(19) United States
(12) Patent Application Publication
(10) Pub. No.: US 2002/0018236 A1
(43) Pub. Date: Feb. 14, 2002

(54) Bi-directional facsimile mechanism using the internet

(76) Inventors: Elon Musk, Mountain View, CA (US); Almir Grbic, Mountain View, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/927,623

(22) Filed: Aug. 9, 2001

Related U.S. Application Data
(63) Continuation of application No. 08/969,120, filed on Nov. 12, 1997, now abandoned.

(51) Int. Cl. B41J 1/00

(52) U.S. Cl. 358/1.15

(57) ABSTRACT

The present invention provides a system for sending and receiving a facsimile of a document. A sending user transmits a facsimile to a facsimile server, along with a recipient identification code. The facsimile server stores the facsimile in a designated facsimile web page, with the facsimile web page being associated with a facsimile uniform resource locator address (hereinafter facsimile URL address). The facsimile server determines an electronic communications location of the retrieving user from the recipient identification code and sends the facsimile URL address to the recipient. The recipient can then retrieve the facsimile by using a web browser.

### BACKGROUND OF THE INVENTION

The present invention relates generally to the receiving and sending of a facsimile of a document over a client-server network, in particular the Internet.

Traditionally, a sender transmits a facsimile of a document to a recipient by using one of several different types of facsimile devices.

With a traditional facsimile machine, the sender inputs the telephone number of a recipient's facsimile device and inserts a paper document. The facsimile machine electronically scans the document to typically create a bit map version of the document which is transmitted through a modem connected to a telephone network.

A computer with a modem can act like facsimile machine with fax software.

Either ASCII encoded electronic documents can be faxed using the computer, or a bit-mapped scanned image could be transmitted. The bit-map image could optionally be converted to ASCII code at either the sender or the recipient. The recipient can be a traditional fax machine or another computer with fax software.

Another method for transmitting electronically stored documents is by using e-mail over a computer network or the Internet, with the electronic document as an attachment, or imbedded in the e-mail message.

### SUMMARY OF THE INVENTION

The present invention provides a system for sending and receiving a facsimile of a document. A sending user transmits a facsimile to a facsimile server, along with a recipient identification code. The facsimile server stores the facsimile in a designated facsimile web page, with the facsimile web page being associated with a facsimile uniform resource locator address (hereinafter facsimile URL address). The facsimile server determines an electronic communications location of the recipient from the recipient identification code and sends the facsimile URL address to the recipient. The recipient can then retrieve the facsimile by using a web browser.

In one embodiment, the facsimile is a scanned, bit map image involving the recipient identification code (hereinafter recipient ID) on the first page. The recipient ID is retrieved by using OCR software on the first page. Preferably, the message to the recipient with the facsimile URL address is sent via e-mail. The sender can use either a modem or e-mail to send the facsimile to the facsimile server.

In another embodiment, the registered web site user sends the facsimile to the business whose URL address is retrieved from a Yellow Pages database. The data is then read by the web server and saved to the Yellow Pages database along with a sending user identification code and recipient Business identification code. The facsimile server reads the Yellow Pages database and generates a bit map image involving the sending user ID and the recipient ID. The sending user's message is generated on subsequent pages. Once the business receives the message, the recipient may reply to the sending user. The information on the front page of the facsimile is used to reply to the sending user via the facsimile server. The OCR then retrieves the recipient ID from the front page. After the recipient ID is recognized by the facsimile server, the facsimile retrieves the sending user's e-mail address from a database and converts the received facsimile file to an image viewable by a web browser. Web pages are then generated and e-mail notification is sent to the user.

The invention will be better understood by reference to the following detailed description in connection with the following drawings.

### BRIEF DESCRIPTION OF THE DRAWINGS

FIG. 1 is a block diagram of a client-server network for sending and receiving a facsimile.

FIG. 2 is a block diagram of a facsimile server which implements the present invention.

FIG. 3 is a flowchart illustrating the operation of the present invention among a facsimile device, a facsimile server, an e-mail system, and a retrieving client for sending and receiving a facsimile via a client-server network.

FIG. 4 is a flowchart illustrating the operation of the facsimile server which implements the present invention.

FIG. 5 illustrates a system block diagram of a typical computer system used to execute the software of the facsimile server in an embodiment of the present invention.

FIG. 6 is a block diagram of the Internet to which the facsimile server according to the present invention can attach to a user client, such as the retrieving client.

### DESCRIPTION OF THE PREFERRED EMBODIMENT

In the description that follows, the present invention is explained in reference to a preferred embodiment that operates on a client-server network using TCP/IP, such as the Internet. However, the present invention can be applied to a network other than the Internet, using protocols other than TCP/IP, such as an asynchronous transfer mode (hereinafter ATM) protocol. Therefore, the description of the preferred embodiment that follows is intended to be illustrative, but not limiting, of the scope of the present invention as set forth in the claims.

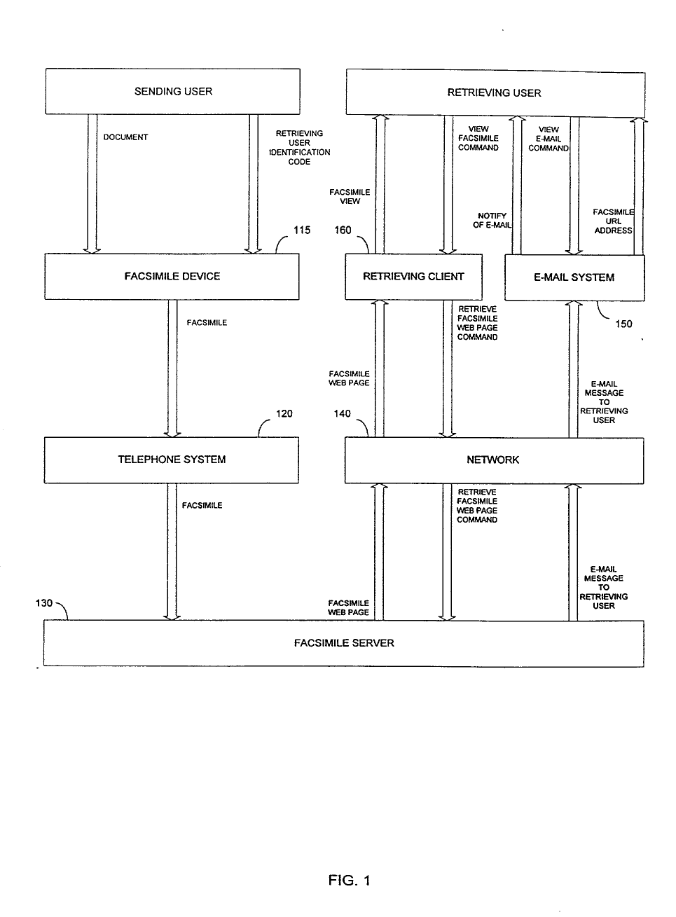

FIG. 1 is a block diagram of a system 110, according to the present invention, for receiving and sending facsimiles. System 110 has a facsimile device 115, a telephone system 120, a facsimile server 130, a network 140, an e-mail system 150, and a retrieving client 160. During the receiving and sending of a facsimile, these components interact in several ways.

During the receiving of a facsimile, a sending user and the facsimile server interact in several ways. Facsimile device 115 receives, from a sending user, a document and a retrieving user identification code, converts the document and the retrieving user identification code into a facsimile, and transmits the facsimile to facsimile server 130 via telephone system 120. Alternately, the facsimile could be sent as an e-mail message or attachment. With regard to the document, in one embodiment, the document is a paper version of the writing and/or graphics in the document and may be scanned by the facsimile device in order to convert the document into a bit map version of the document. In an alternate embodiment, the document is in electronic form already, but, still may be converted to a bit map version of the document.

After the facsimile has been received and stored in a web page by the facsimile server, the facsimile server and the retrieving user interact in several ways. Facsimile server 130 sends an e-mail message with a facsimile URL address associated with a facsimile web page, to the retrieving user via network 140 and e-mail system 150 for display to the retrieving user on a display device of e-mail system 150. E-mail system 150 notifies the retrieving user of the received e-mail message, accepts a “view email command” from the retrieving user, and displays the facsimile URL address on the display device of e-mail system 150. Retrieving client 160 runs a web browser, through which the retrieving user inputs the facsimile URL address, and, thereafter, requests the facsimile web page associated with the inputted facsimile URL address via network 140 from facsimile server 130. Facsimile server 130 delivers the facsimile web page associated with the inputted facsimile URL address to retrieving client 160 via network 140. Retrieving client 140, which runs the web browser, also displays a facsimile view to the retrieving user by displaying the facsimile web page within the web browser.

Although not sender initiated like a fax, web sites allow users to access and retrieve documents from a web site using a web browser. Each web site comprises at least one network page, such as a network page written in HyperText Markup Language (hereinafter HTML), with each network page being stored in a computer file in the web server housing the web site. Each network page is understandable to and displayable by the web browser and can comprise at least one hypertext link to a computer file stored in a computer within the Internet. A unique uniform resource locator (hereinafter URL) address provides the location within the Internet of each such computer file and of each computer file storing a network page within the client-server network called the Internet. A hypertext link in each network page is a reference to an URL address and is represented by text or a graphic displayed by the web browser on the display of the client. A user accesses the computer file associated with the hypertext link by either clicking on the text or graphic with the pointing device of the client or by entering the URL address referenced by the hypertext link with the keyboard of the client. Each facsimile can either be stored as a separate web site, or a separate web page of a web site. If separate pages are used, the recipient can be sent a password required for security. The security is enhanced by the facsimile server 130 randomly generating the image and HTML file names. The file names are a combination of characters such as a string of letters and numbers. Furthermore, if the recipient of these files does not view these files for a selected period of time, the files are deleted to provide additional security. Typically, the selected period of time is 30 days.

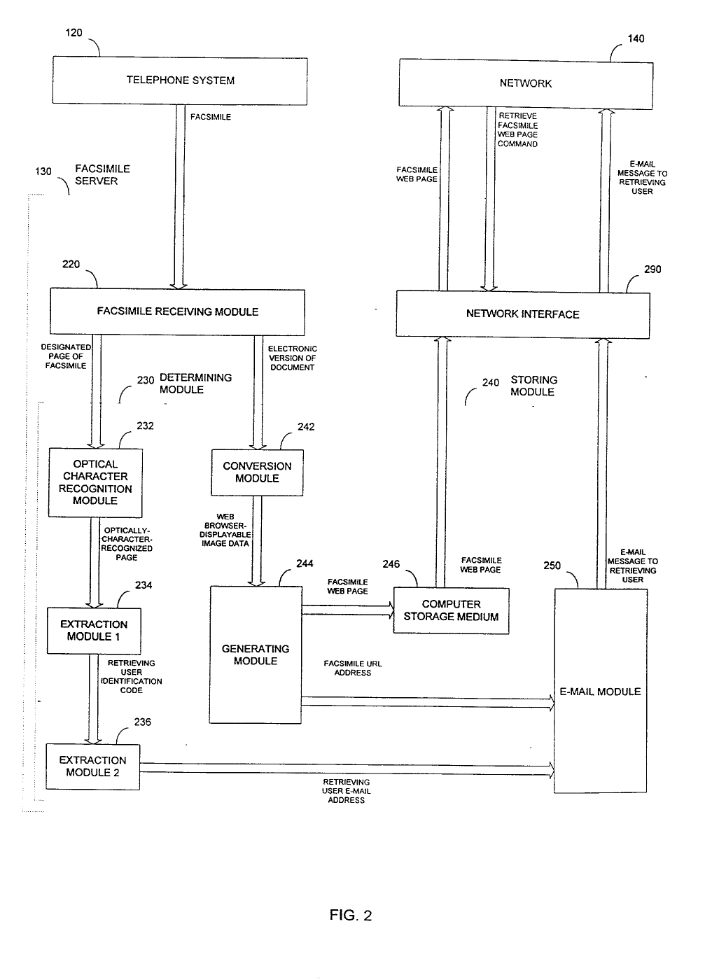

FIG. 2 is a block diagram of system 210 with a typical facsimile server 130 which implements the present invention, telephone system 120, and network 140. Facsimile server 130 has a facsimile receiving module 220, a determining module 230, a storing module 240, an e-mail module 250, and a network interface 290. Facsimile receiving module 220 receives a facsimile from facsimile device 115 via telephone system 120.

Determining module 230 has an optical character recognition module 232, a first extraction module 234, and a second extraction module 236. Optical character recognition module 232 retrieves the designated page of the facsimile from facsimile receiving module 220 and optically-character-recognizes the text on the designated page (preferably the first page) of the facsimile. First extraction module 234 extracts the retrieving user identification code of a retrieving user from the optically-character-recognized page. Second extraction module 236 extracts a retrieving user e-mail address from the extracted retrieving user identification code of the retrieving user. The user identification code is the user identifier which can be retrieved from the table of registered users.

Storing module 240 includes a conversion module 242, a generating module 244, and a computer storage medium 246. Conversion module 242 retrieves an electronic version of a document from facsimile receiving module 220 and converts this electronic version of the document into web browser-displayable image data. Generating module 244 retrieves the web browser-displayable image data from conversion module 242, and, creates a facsimile web page, stores this facsimile web page in computer storage medium 246, and creates a facsimile URL address associated with the facsimile web page. In one embodiment, this computer storage medium is located within facsimile server 130.

The readable data in text files or the visual data in image files are “web browser-displayable” if the textual data or the visual data are in a file format which the web browser understands and can display. For example, the Netscape web browser and the Microsoft Explorer web browser both can understand and display the readable data in ASCII text files and can display the visual data in JPEG and GIF image files. Therefore, readable data in ASCII text files are “web browser-displayable” readable data, and, visual data in JPEG and GIF image files are “web browser-displayable” image data. A hypertext link to “web browser-displayable” data is a reference in a network page to the URL address of the computer file containing the “web browser-displayable” data. Therefore, a hypertext link to “web browser-displayable” image data is a reference in a network page to the URL address of the image file containing the “web browser-displayable” image data.

E-mail module 250 sends a facsimile URL address to the retrieving user. E-mail module 250 retrieves a retrieving user e-mail address from second extraction module 236 within determining module 230, retrieves a facsimile URL address from generating module 244 within storing module 240, and, generates an e-mail message to the retrieving user. E-mail module 250 also transmits the facsimile URL address within the e-mail message to network interface 290.

Network interface 290 transmits the e-mail message with the facsimile URL address to the retrieving user via network 140 and e-mail system 150. In addition, network interface 290 receives the facsimile URL address within a “retrieve facsimile web page command” from retrieving client 160 via network 140. In response to this “retrieve facsimile web page command”, network interface 290 retrieves the facsimile web page associated with this facsimile URL address from computer storage medium 246, and, subsequently, transmits this facsimile web page to the retrieving user via network 140 and retrieving client 160.

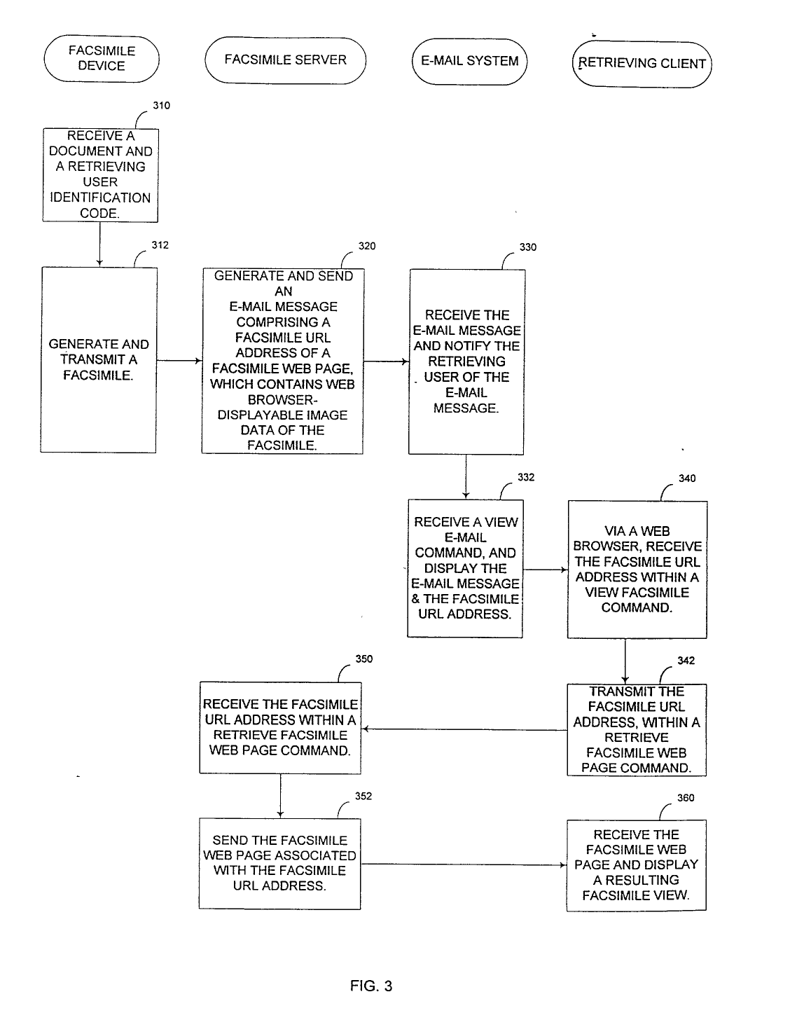

FIG. 3 is a flowchart illustrating the operation of the present invention among a facsimile device, a facsimile server, an e-mail system, and a retrieving client for receiving and sending a facsimile via a client-server network. First, at step 310, the facsimile device receives a document and a retrieving user identification code from a sending user. Next, at step 312, the facsimile device generates a facsimile with an electronic version of the document and the retrieving user identification code and transmits the facsimile to the facsimile server via a telephone system. Afterwards, at step 320, the facsimile server generates and sends to the e-mail system an e-mail message with a facsimile URL address of a facsimile web page, in which the facsimile has been electronically stored.

Next, at step 330, the e-mail system receives the e-mail message and notifies the retrieving user of the received e-mail message. At step 332, the e-mail system receives a “view e-mail command” from the retrieving user and displays the facsimile URL address on the display device of the e-mail system. Next, at step 340, the retrieving client, which is running a web browser, receives the facsimile URL address within a “view facsimile command.” Afterwards, at step 342, the retrieving client requests the facsimile web page associated with the inputted facsimile URL address by transmitting the facsimile URL address within a “retrieve facsimile web page” command.

At step 350, the facsimile server receives the facsimile URL address within a “retrieve facsimile web page” command. Next, at step 352, the facsimile server sends the facsimile web page associated with this facsimile URL address to the retrieving client. Finally, at step 360, the retrieving client, which is still running the web browser, receives this facsimile web page and displays a facsimile view to the retrieving user by displaying the facsimile web page within the web browser.

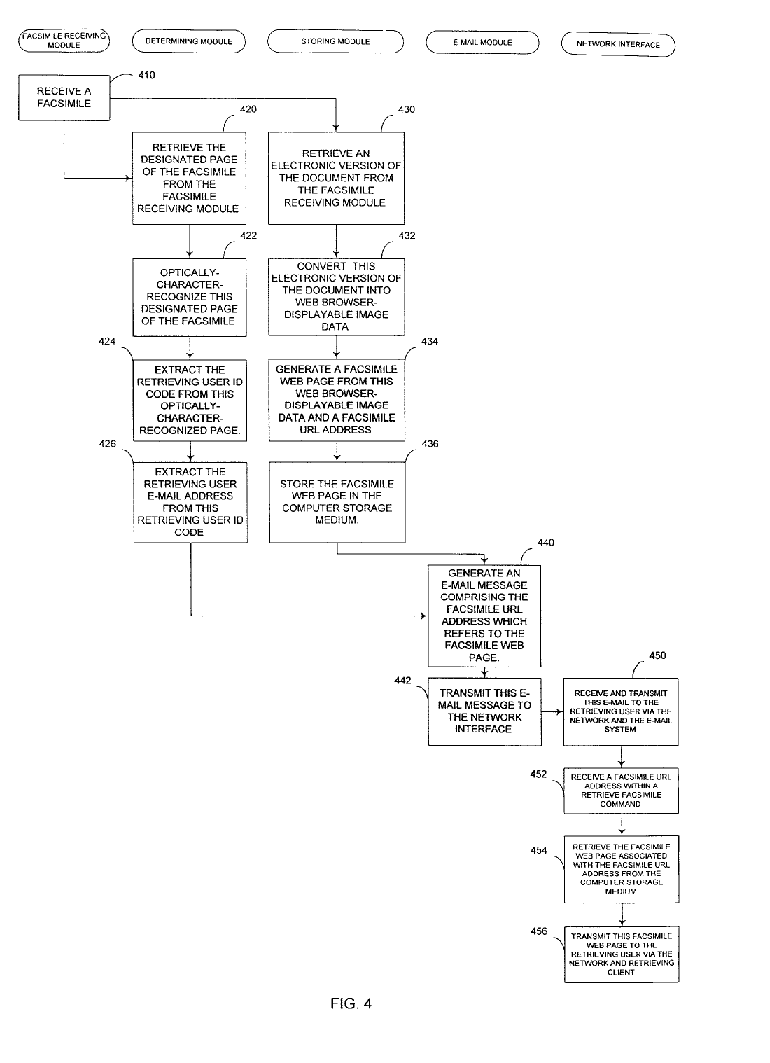

FIG. 4 is a flowchart illustrating the operation of a facsimile server which implements the present invention. The determining module within the facsimile server performs several functions. First, at step 410, the facsimile receiving module receives a facsimile from a facsimile device via a telephone network. Then, at step 420, the determining module retrieves a designated page of the facsimile from the facsimile receiving module. Next, at step 422, the determining module optically-character-recognizes the designated page of the facsimile to produce an optically-character-recognized page. At step 424, the determining module extracts the retrieving user identification code (hereinafter retrieving user ID code) from this optically-character-recognized page. Finally, at step 426, the determining module extracts the retrieving user e-mail address from the extracted retrieving user ID code.

The storing module within the facsimile server also performs several functions. First, at step 430, the storage module retrieves an electronic version of the document which had been sent as a facsimile. Then, at step 432, the storage module converts this electronic version of the document into web browser-displayable image data. Next, at step 434, the storage module generates a facsimile web page from this web browser-displayable image data and generates a facsimile URL address for this web browser-displayable image data. Finally, at step 436, the storage module stores this facsimile web page in a computer storage medium.

In step 440, the e-mail module generates an e-mail message with this facsimile URL address. Afterwards, in step 442, the e-mail module transmits this e-mail message to the network interface.

Next, in step 450, the network interface receives and transmits this e-mail message to the retrieving user via the network and the e-mail system. In step 452, the network interface receives a facsimile URL address within a “retrieve facsimile web page command. ” Next, in step 454, the network interface retrieves the facsimile web page associated with this facsimile URL address from the computer storage medium. Finally, in step 456, the network interface transmits this facsimile web page to the retrieving user via the network and the retrieving client.

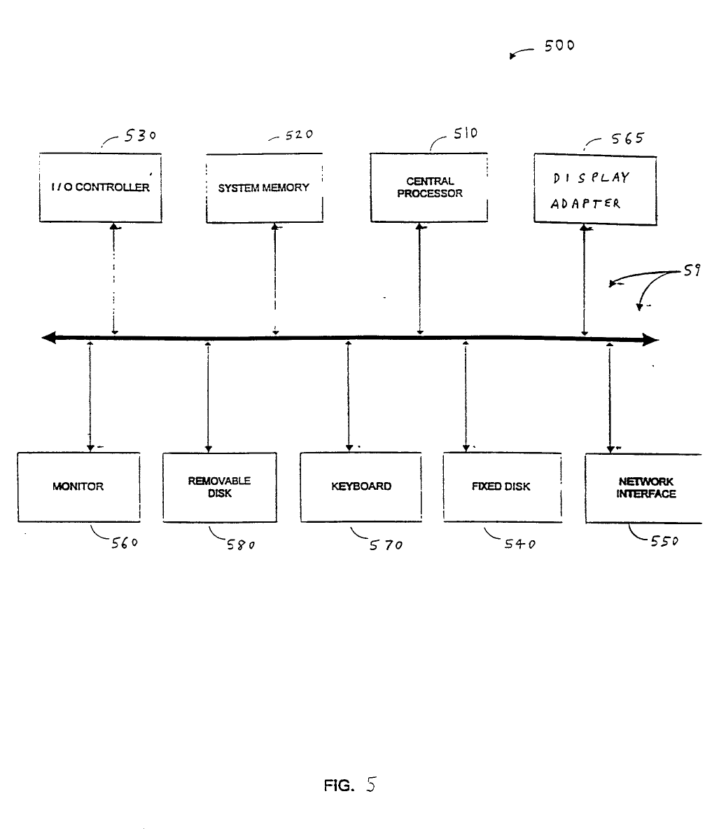

FIG. 5 illustrates a system block diagram of a typical computer system 500 used to execute the software of facsimile server 130 in an embodiment of the present invention. Computer system 500 includes subsystems such as a central processor 510, a system memory 520, an I/O controller 530, a fixed disk 540, and a network interface 550. Computer system 500 may also include a monitor 560, a display adapter 565, a keyboard 570, and a removable disk 580. Other computer systems suitable for use with the present invention may include additional or fewer subsystems. For example, another computer system could include more than one processor 510 (i.e., a multi-processor system) or a cache memory as part of system memory 520.

Arrows such as 590 represent the system bus architecture of computer system 500. However, these arrows are illustrative of any interconnection scheme serving to link the subsystems. For example, a local bus could be utilized to connect the central processor to the system memory and display adapter. Computer system 500 is but an example of a computer system suitable for use with the present invention. Other configurations of subsystems suitable for use with the present invention will be readily apparent to one of ordinary skill in the art.

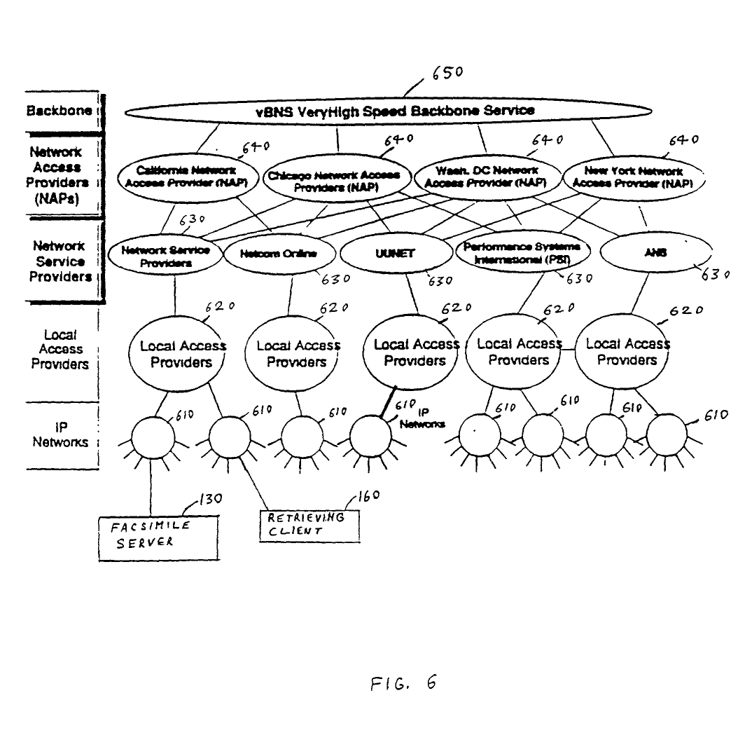

FIG. 6 is a block diagram of the Internet 600 to which a facsimile server 130 according to the present invention can attach to a user client, such as retrieving client 160. In the example shown, a number of Internet provider networks 610 provide connection to local access providers 620, which then provide access to network service providers 630. The network service providers then connect to network access providers 640, which, in turn, are connected to the backbone service 650. It should be understood that other configurations of the Internet or other networks could be used with the present invention.

The invention has been explained with reference to a specific embodiment. Other embodiments will be apparent to those of ordinary skill in the art. It is therefore not intended that this invention be limited, except as indicated by the appended claims.

What is claimed is:

1. A method of providing access to a facsimile of a document, comprising:
receiving from a sending user said facsimile, said facsimile comprising an electronic version of said document and a retrieving user identification code of a retrieving user; and
in response to receiving said facsimile from said sending user:
determining an electronic communications location of said retrieving user from said retrieving user identification code;
converting said electronic version of said document into web browser displayable image data;
generating a facsimile web page from said web browser displayable image data;
assigning a uniform resource locator (URL) to said facsimile web page;
sending said uniform resource locator address (URL) to said retrieving user at said electronic communications location; and
providing access to said web browser displayable image data via said uniform resource locator, wherein access to said facsimile web page is password protected.

2. The method of claim 1 wherein said retrieving user identification code is located on a designated page of said facsimile.

3. The method of claim 2 wherein said designated page of said facsimile is a first page of said facsimile.

4. The method of claim 1 wherein determining said electronic communications location of said retrieving user from said retrieving user identification code comprises:
optically-character-recognizing a designated page of said facsimile, thereby generating an optically-character-recognized page;
extracting said retrieving user identification code from said optically-character-recognized page; and thereafter,
extracting said electronic communications location of said retrieving user from said extracted retrieving user identification code.

5. The method of claim 1 wherein said electronic communications location is an e-mail address.

6. The method of claim 1 wherein sending said uniform resource locator address (URL) to said retrieving user at said electronic communications location comprises generating an e-mail message addressed to said retrieving user, said e-mail message comprising said facsimile uniform resource locator address.

7. An apparatus for providing access to a facsimile of a document, comprising:
a receiving module configured to receive from a sending user said facsimile, said facsimile comprising an electronic version of said document and a retrieving user identification code of a retrieving user; and
a plurality of modules configured to perform processing in response to said receiving module receiving said facsimile, said plurality of modules comprising:
a determining module configured to determine an electronic communications location of said retrieving user from said retrieving user identification code;
a conversion module configured to convert said electronic version of said document into web browser displayable image data;
a web page generation module configured to generate a facsimile web page from said web browser displayable image data;
an assigning module configured to assign a uniform resource locator (URL) to said facsimile web page; and
a sending module configured to send said uniform resource locator (URL) address to said retrieving user at said electronic communications location, wherein said uniform resource locator provides access to said web browser displayable image data only for a predetermined period of time.

8. The apparatus of claim 7 wherein said retrieving user identification code is located on a designated page of said facsimile.

9. The apparatus of claim 8 wherein said designated page of said facsimile is a first page of said facsimile.

10. The apparatus of claim 7 wherein said determining module comprises:
an optical-character-recognition module configured to optically-character-recognize a designated page of said facsimile, thereby generating an optically-character-recognized page;
a first extracting module configured to extract said retrieving user identification code from said optically-character-recognized page; and
a second extracting module configured to extract said electronic communications location of said retrieving user from said extracted retrieving user identification code.

11. The apparatus of claim 7 wherein said electronic communications location is an e-mail address.

12. The apparatus of claim 7 wherein said sending module comprises a generating module configured to generate an e-mail message addressed to said retrieving user, said e-mail message comprising said facsimile uniform resource locator address.

13. A computer program product stored on a computer-readable storage medium for providing access to a facsimile of a document, comprising:
code for receiving from a sending user said facsimile, said facsimile comprising an electronic version of said document and a retrieving user identification code of a retrieving user; and
in response to receiving said facsimile from said sending user:
code for determining an electronic communications location of said retrieving user from said retrieving user identification code;
code for converting said electronic version of said document into web browser displayable image data;
code for generating a facsimile web page from said web browser displayable image data, wherein the facsimile web page is stored in a computer file that has a randomly generated file name;
code for assigning a uniform resource locator (URL) to said facsimile web page;
code for sending said uniform resource locator address (URL) to said retrieving user at said electronic communications location; and
code for providing access to said web browser displayable image data via said uniform resource locator.

14. The computer product of claim 13 wherein access to said web browser displayable image data is password protected.
